(19) United States
(12) Patent Application Publication
(10) Pub. No.: US 2018/0231700 A1
(43) Pub. Date: Aug. 16, 2018

(54) LENS ARRANGEMENT FOR COMPACT VIRTUAL REALITY DISPLAY SYSTEM

(71) Applicants: Khaled AHMED, Anaheim, CA (US); Kunjal PARIKH, San Jose, CA (US); Rajesh MENON, Lexington, MA (US)

(72) Inventors: Khaled AHMED, Anaheim, CA (US); Kunjal PARIKH, San Jose, CA (US); Rajesh MENON, Lexington, MA (US)

(21) Appl. No.: 15/892,868

(22) Filed: Feb. 9, 2018

Related U.S. Application Data
(60) Provisional application No. 62/457,697, filed on Feb. 10, 2017.

(51) Int. Cl. G02B 5/18; G06F 1/16

(52) U.S. Cl. CPC G02B 5/1814; G02B 2207/101; G06F 1/163; G02B 5/1809

(57) ABSTRACT

An apparatus to display virtual reality scenes is provided. The apparatus may include a display to emit visible light. A flat lens may be optically coupled to the display, where a focal length of the flat lens for at least a portion of the visible light is not more than 20 millimeters.

### CLAIM OF PRIORITY

This Application is a Non-Provisional of, and claims priority to, U.S. Provisional Application No. 62/457,697, filed on 10 Feb. 2017 and titled “COMPACT VIRTUAL REALITY DISPLAY SYSTEMS”, which is incorporated by reference in its entirety for all purposes.

### BACKGROUND

Devices displaying virtual reality scenes are becoming increasingly popular. For example, a head mounted display device may be mounted on a user's head, and the device may display virtual reality scenes in front of the user's eyes. It is useful to have a virtual reality display device with relatively high field of view, small size, and low cost, without sacrificing an image resolution.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIGS. 1A and 1B illustrate a device that includes a flat lens positioned between a display screen and a viewing area, according to some embodiments.

FIGS. 2A-2C illustrate examples of a section of the lens of the device of FIGS. 1A-1B, according to some embodiments.

FIG. 3 illustrates diffraction of incident light by the lens of the device of FIGS. 1A-1B, according to some embodiments.

FIGS. 4A-4C illustrate optical response of different types of lenses, according to some embodiments.

FIGS. 5A-5C illustrate different graphs depicting relationship between wavelength of light and change in focal length for different types of lenses, according to some embodiments.

FIG. 6 illustrates an example use case scenario of the device of FIGS. 1A-1B, according to some embodiments.

FIG. 7 illustrates a computing device, a smart device, a computing device or a computer system or a SoC (System-on-Chip), where the computing device may include an emissive display to emit visible light, and a flat lens optically coupled to the emissive display, according to some embodiments.

### DETAILED DESCRIPTION

A virtual reality (VR) display device may include a display screen to display virtual reality scenes. For example, the display screen may emit visible light while displaying the virtual reality scenes. In some embodiments, a lens is optically coupled to the display screen. For example, the lens may be placed between the display screen and a viewing area (e.g., where a user is to place an eye).

In some embodiments, a flat lens is used in the VR device. For example, the flat lens may be a multi-level diffractive flat lens, e.g., may be a diffractive optical element comprising a plurality of nanostructures or nanoparticles. Individual nanostructure may have a plurality of levels or steps. In another example, the flat lens may be based on meta-surfaces. As discussed throughout this disclosure, using a flat lens may result in reduction in size and/or price of the VR device, e.g., without sacrificing a target field of view requirement or an eye box requirement. Other technical effects will be evident from the various embodiments and figures.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.” The terms “substantially,” “close,” “approximately,” “near,” and “about,” generally refer to being within +/−10% of a target value.

Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C). The terms “left,” “right,” “front,” “back,” “top,” “bottom,” “over,” “under,” and the like in the description and in the claims, if any, are used for descriptive purposes and not necessarily for describing permanent relative positions.

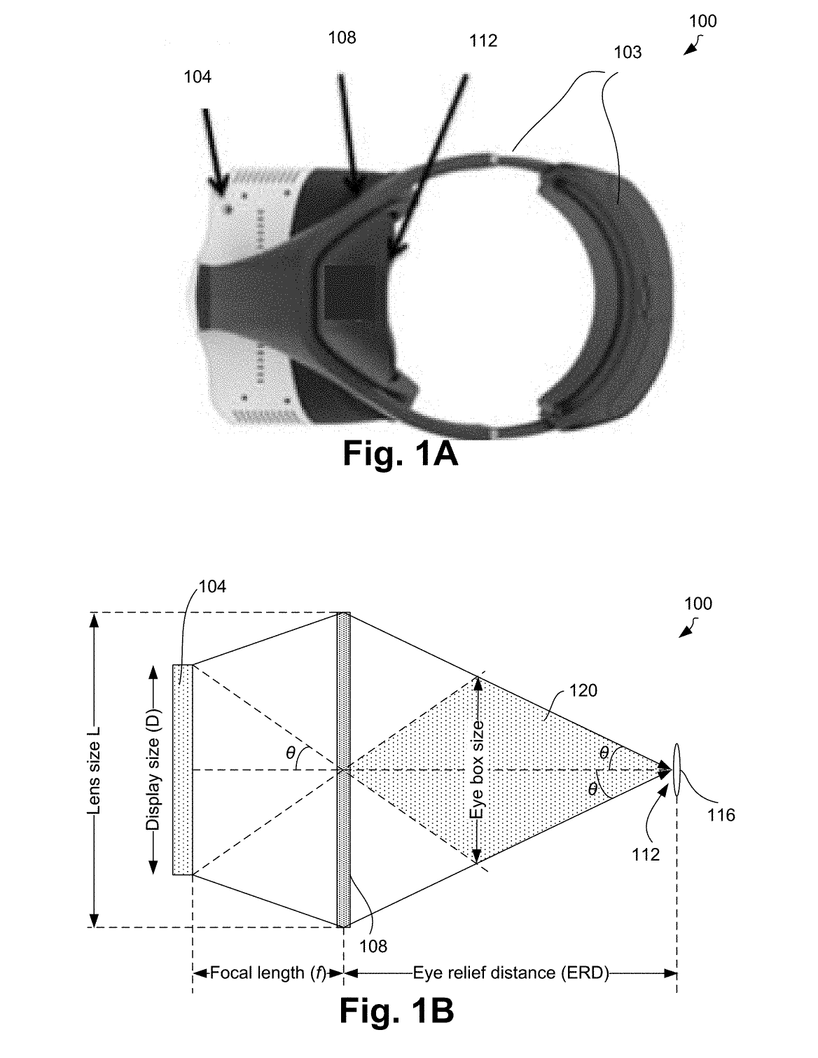

FIGS. 1A and 1B illustrate a device 100 that includes a flat lens 108 positioned between a display screen 104 and a viewing area 112, according to some embodiments. FIG. 1B is a schematic top view illustration of the device 100, and illustrates only some of the components of the device 100.

Referring to FIGS. 1A-1B, in some embodiments, the device 100 includes the display screen 104 (also referred to as display 104). The display screen 104 may be an emissive display screen, e.g., may emit visible light. For example, a memory (not illustrated in FIGS. 1A-1B) of the device 100 may store VR contents (e.g., video contents, pictures, etc.), and one or more circuitries of the device 100 (e.g., a graphic processor, a content rendering engine, etc., not illustrated in FIGS. 1A-1B) may render such content on the display screen 104.

In some embodiments, the device 100 includes mounting components 103 to mount the device 100 on a user's head. For such embodiments, the device 100 may be a Head Mounted Device (HMD). For example, a user may mount or wear the device 100 on his or her head, e.g., using the mounting components 103. The device 100 may be a wearable device. In some embodiments, when the device 100 is mounted on a head of a user, the eyes of the user may be positioned in a viewing area 112 (an eye 116 is illustrated in FIG. 1B). The viewing area 112 may be in a position such that the display screen 104 is visible from the viewing area 112 through the lens 108.

In some examples, the device 100 may not be a head mounted device. For example, the user may place her eyes in the viewing area 112, without mounting the device 100 is her head.

In some embodiments and although not illustrated in FIGS. 1A-1B, the device 100 may comprise one or more tracking circuitries that may track a movement of the device 100. For example, when the device 100 is worn by a user and the user moves the head (e.g., which results in corresponding movement in the device 100), such movement may be tracked by the device 100. Such tracking may be used as a feedback to change the contents displayed in the display screen 104. The tracking circuitries may comprise, merely as examples, a gyroscope, an accelerometer, a motion detection sensor, etc.

A lens 108 may be arranged between the display screen 104 and the viewing area 112. In some embodiments, the lens 108 is a flat lens, e.g., a diffractive optical element comprising a plurality of nanostructures or nanoparticles, as will be discussed in further details herein.

In some examples, the device 100 may comprise two display screens, two corresponding lenses, and two corresponding viewing areas, e.g., one for the left eye and one for the right eye. However, merely one display screen 104, one lens 104, and one viewing area 112, e.g., corresponding to one eye 116, are illustrated in the top view of FIG. 1B. Thus, FIG. 1B illustrate an arrangement for one eye, and the arrangement may be duplicated for another eye as well.

In some embodiments, the display screen 104 displays virtual reality scenes. In an example, virtual reality may provide a person with the feeling of actually being at a specific location, which may be real or imaginary. In an example, a compactness of the device 100, while offering reasonably high image quality, may be useful. For example, it may be useful to have relatively wide viewing angles (e.g., viewing angle may be 2*θ, where the angle θ is illustrated in FIG. 1B). Human field of view (FOV) may span about 200 degrees horizontally, taking into account both eyes, and about 135 degrees vertically.

In some embodiments, the lens 108 may be a flat lens, e.g., a diffractive optical element comprising a plurality of nanostructures or nanoparticles. For example, a flat lens may be a lens whose relatively flat shape may allow it to provide distortion-free imaging, potentially with arbitrarily-large apertures. The term flat lens may also be used to refer to other lenses that provide a negative index of refraction.

In some embodiments, the lens 108 may be made from subwavelength or superwavelength particles (e.g., nanoparticles or nanostructures). In an example, the subwavelength or superwavelength particles may range between 200-400 nanometers (nm). In an example, the subwavelength or superwavelength particles may be less than 300 nm.

In some embodiments, the lens 108 may rely on diffraction of incident light to produce desired lensing function. In an example, the lens 108 may be based on binary optics or Diffractive Optical Element (DOE). DOE is an emerging technology which introduces a diffractive element, where the optical performance of the diffractive element is governed by the grating equation. In an example, the name binary optics may be traced to computer-aided design and fabrication of these elements. For example, the computer defines a stepped (or binary) microstructure which acts as a specialized grating. By varying the shape and pattern of this diffractive structure, properties of the diffractive element can be adapted to a wide range of applications such as lenses.

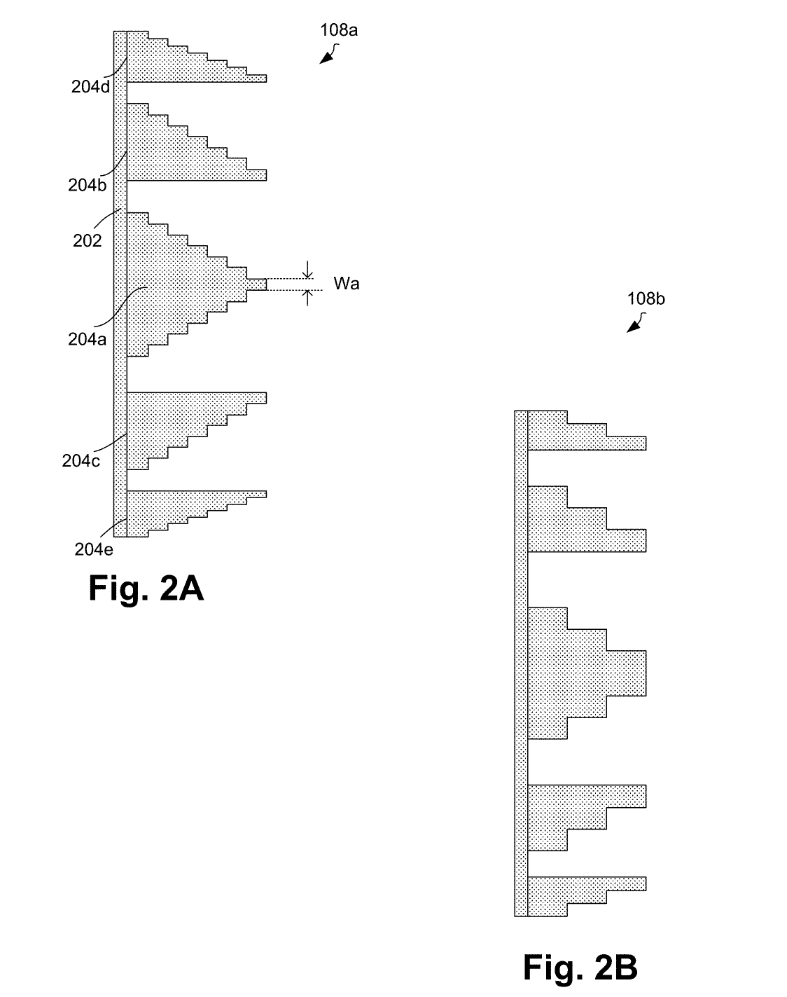

A diffractive optical element, which may be used for the lens 108, may be a computer generated synthetic lens, which may be relatively flat and thin. The lens structure may be a fringe pattern, and may need minimum feature sizes less than 300 nm (feature size of the lens 108 is discussed herein later). In comparison to a conventional refractive or reflective bulky optics (e.g. lenses), DOEs may not suffer from normal image aberrations, e.g., because DOEs perform diffraction limited imaging. High efficiency may be achieved by DOEs with multilevel relief structures, e.g., multiple levels of nanostructures forming the lens, as discussed herein later with respect to FIGS. 2A-2C.

A feature size of the lens 108 (e.g., discussed herein later in further details), which may be a DOE, may be determined by diffraction theory that describes the relationship between numerical aperture of the lens, the wavelength of light, and the nanoparticle size. For example:

$$W \approx \frac{λ}{2 * NA} , \qquad Equation 1$$

where W may be a feature size of the lens 108, A may be the wavelength of light (e.g., light emitted by the display 104, which may be in the range of 465 nm-630 nm), and NA may be a numerical aperture of the lens 108.

FIGS. 2A-2C illustrate examples of a section of the lens 108, according to some embodiments. For example, each of these figures illustrate corresponding example implementation of the lens 108.

Referring to FIG. 2A, illustrated is an example lens 108a (which may be a DOE), which may be used as the lens 108 in the device 100. In some embodiments, the DOE lens 108a includes a plurality of nanostructures or nanoparticles 204a, 204b, 204c, 204d, 204e, etc., formed on a base 202. Although only five nanostructures are illustrated in FIG. 2A, the lens 108a may include any different number of nanostructures.

In an example, a central nanostructure 204a has a larger width than two adjacent nanostructures 204b and 204c. In an example, the nanostructures 204b and 204c may have substantially similar width. In an example, the nanostructures 204d and 204e may have substantially similar width, which may be smaller than the widths of the nanostructures 204b and 204c. Thus, the central nanostructure 204a has the largest width, and the width of the nanostructures becomes smaller towards the ends of the lens 108a.

In some embodiments, each of the nanostructures 204a, 204b, 204c, 204d, 204e has multiple steps or levels. For example, the number of levels in the nanostructures 204a, 204b, 204c, 204d, 204e is 8 (note that in FIGS. 2B and 2C, the number of levels in the nanostructures are four and two, respectively). As the number of levels in the nanostructures 204a, 204b, 204c, 204d, 204e of the lens 108a of FIG. 2A is 8, the lens 108a is also referred to as an octernary lens.

In an example, the central nanostructure 204a has steps or levels on both sides. In an example, each of the nanostructures 204b, 204c, 204d, and 204e has steps or levels on a corresponding first side (e.g., where the first side is opposite to a corresponding second side facing the central nanostructure 204a), and has a vertical edge on the corresponding second side, as illustrated in FIG. 2A.

In some embodiments, a step size or level size of the central nanostructure 204a is referred to as Wa. Similarly, nanostructures 204b, . . . , 204e may have corresponding step sizes. An average of the step sizes of the various nanostructures 204a, . . . , 204e is referred to as a feature size W of the lens 108a (e.g., see equation 1).

Referring now to FIG. 2B, the lens 108b may also include a plurality of nanostructures, e.g., similar to the lens 108a of FIG. 2A. However, unlike the lens 108a of FIG. 2A (e.g., in which the number of levels in the nanostructures was 8), in the lens 108b the number of levels in the various nanostructures is 4. As the number of levels in the nanostructures of the lens 108b of FIG. 2B is 4, the lens 108b is also referred to as a quaternary lens.

Referring now to FIG. 2C, the lens 108c may also include a plurality of nanostructures, e.g., similar to the lens 108a of FIG. 2A. However, unlike the lens 108a of FIG. 2A (e.g., in which the number of levels in the nanostructures was 8), in the lens 108c the number of levels in the various nanostructures is 2. As the number of levels in the nanostructures of the lens 108c of FIG. 2C is 2, the lens 108c is also referred to as a binary lens.

Although lenses with numbers of levels 8, 4, and 2 are respectively illustrated in FIGS. 2A, 2B, and 2C, the nanostructures of the lens 108 of the device 100 may include any different number of levels. For example, the number of levels in the lens 108 may be 8, 16, 32, or even higher. In some embodiments, the lens 108 may also be referred to as a multi-level diffractive flat lens, a multi-level diffractive optical element, a lens with multi-level nanostructures, and/or the like.

In some embodiments, a diffraction efficiency of the lens 108 may increase with an increase in the number of levels. For example, the diffraction efficiency of the lens 108c of FIG. 2C having two levels may be about 40%; the diffraction efficiency of the lens 108b of FIG. 2B having four levels may be about 82%; and the diffraction efficiency of the lens 108a of FIG. 2A having eight levels may be about 95%. Lenses with even higher number of levels (e.g., 16, 32, etc.) may have higher diffraction efficiency.

It may be noted that the multi-level diffractive optical element lens 108 may be different from a Fresnel lens. For example, unlike the lens 108, a Fresnel lens may not image over the visible spectrum without significant aberrations, and a Fresnel lens may significantly curtail achievable resolution and field of view.

In some embodiments, the lens 108 (e.g., any of the lenses 108a, 108b, 108c) may include an appropriate wide bandgap dielectric. For example, the material of the lens 108 may be transparent and relatively easily molded into the designed geometry (e.g., the geometry of any of FIGS. 2A-2C, or any other appropriate geometry). In an example, the lens 108 may include one or more of: Poly(methyl methacrylate) (PMMA), Polyethylene terephthalate (PET), Polystyrene (PS), Polycarbonate (PC), Silicon dioxide (SiO2), Titanium dioxide (TiO2), or the like. Thus, the lens 108 may comprise one or more of: Carbon, Oxygen, Hydrogen, Silicon, or Titanium.

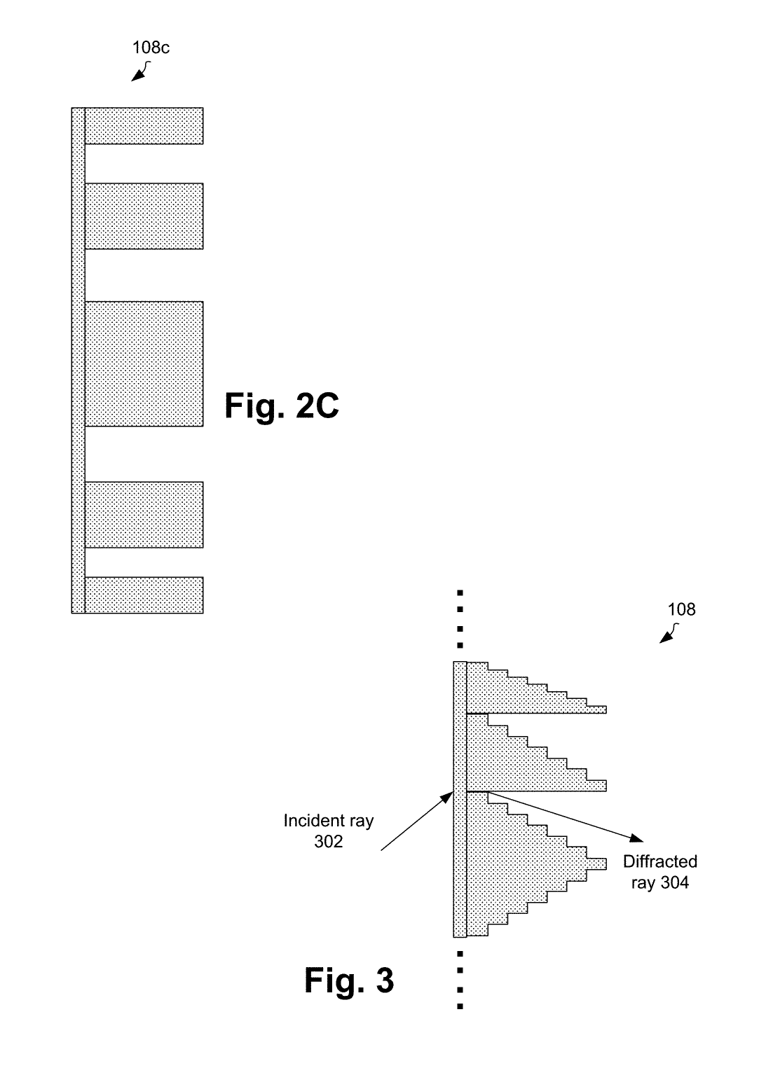

As discussed herein earlier, the lens 108 may rely on diffraction of incident light to produce desired lensing function. The feature size W of the lens 108 may be determined by diffraction theory that describes the relationship between numerical aperture of the lens, the wavelength of light, and the nanoparticle size (e.g., as discussed with respect to equation 1). For example, FIG. 3 illustrates diffraction of incident light by the lens 108, according to some embodiments. FIG. 3 illustrates a section of the lens 108, an incident ray 302, and diffracted ray 304 that is diffracted by the lens 108.

Although FIGS. 2A-2C illustrate the flat lens 108 being implemented as a diffractive optical element including multiple multi-level nanostructures, another appropriate type of flat lens may also be used in the device 100. As an example, a flat lens based on meta-surfaces may also be used as lens 108 in the device 100. For example, the flat lens 108 may employ meta-materials (e.g., meta-atoms), e.g., electromagnetic structures engineered on subwavelength scales, to elicit tailored polarization responses.

Referring again to FIG. 1B, in an example, a size (e.g., a length, as illustrated in the top view of FIG. 1B) of the display screen 104 is labelled as D (e.g., in millimeters or mm), a size (e.g., a length) of the lens 108 is labelled as L (e.g., in mm), and a distance between the lens 108 and the viewing point 112 is referred to as Eye Relief Distance (ERD). Thus, the eye 116 may be placed at about the ERD from the lens 108. The shaded region 120 in FIG. 1B is referred to as eye box of the lens arrangement of the device 100. A horizontal Field of View (FOV) is given by 2*θ, where the angle θ is illustrated in FIG. 1B. NA may be a numerical aperture of the lens 108. In an example, a focal length of the lens 108 for at least a portion of the visible light emitted by the display screen 104 may be about f (in mm), where the lens 108 is at a distance f from the display screen 104. W is the feature size of the lens 108 (in nm), e.g., as discussed with respect to FIGS. 2A-2C and equation 1. A may be the wavelength (in nm) of at least a portion of the visible light emitted by the display screen 104.

In an example, the numerical aperture NA may be represented by:

$$NA ≡ sin ( {tan}^{- 1} \frac{\frac{D}{2}}{f} ) , \qquad Equation 2$$

where the above equation 2 may be modified as:

$$\begin{matrix}{sin}^{- 1} ( NA ) = {tan}^{- 1} ( \frac{\frac{D}{2}}{f} ) , & Equation 3 \\ \frac{\frac{D}{2}}{f} = tan ( {sin}^{- 1} ( NA ) ) .. & Equation 4\end{matrix}$$

The FOV is given by:

$$FOV = 2. {tan}^{- 1} ( \frac{L \text{/} 2}{ERD} ) . \qquad Equation 5$$

The feature size W is given by:

$$W \approx \frac{λ}{2 * NA} , . \qquad Equation 6$$

A size of the eye box 120 is given by:

$$\begin{matrix}Eye box size = L - 2. ERD . tan ( \frac{FOV}{2} ) , & Equation 7 \\ where field of vision FOV = 2. θ .. & Equation 8\end{matrix}$$

Table I below shows values of various variables of equations 1-8 for three different example implementations of the device 100. Table I also illustrates example values for a device having a conventional lens (referred to as conventional device).

TABLE I

| | | | | | Display | | | | |
|---|---|---|---|---|---|---|---|---|---|
| | Eye | | Display | Lens | to lens | | | | Feature |
| | box | FOV | size D | size L | distance | ERD | | λ | size W |
| | (mm) | (degree) | (mm) | (mm) | f (mm) | (mm) | NA | (nm) | (nm) |
| Conventional | 12 | 80 | 50 | 32 | 30 | 12 | 0.64 | 470 | — |
| device | | | | | | | | | |
| 1^{st} example | 12 | 80 | 30 | 35 | 12 | 14 | 0.78 | 470 | 301 |
| implementation | | | | | | | | | |
| of device 100 | | | | | | | | | |
| 2^{nd} example | 12 | 85 | 30 | 38 | 12 | 14 | 0.78 | 470 | 301 |
| implementation | | | | | | | | | |
| of device 100 | | | | | | | | | |
| 3^{rd} example | 12 | 100 | 30 | 45 | 10 | 14 | 0.83 | 470 | 282 |
| implementation | | | | | | | | | |
| of device 100 | | | | | | | | | |

Thus, the first row of Table I is for a device with a conventional lens (e.g., a concave lens), and the second, third, and fourth rows of Table I are for three example implementations of the device 100 of FIGS. 1A-3. As seen, the numerical apertures NA for the three example implementations of the device 100 are 0.78, 0.78, and 0.83, respectively. In an example, the numerical apertures NA of the lens 109 may be relatively high, e.g., 0.60 or higher (or 0.70 or higher).

The focal lengths f for the three example implementations of the device 100 are 12 mm, 12 mm, and 10 mm, respectively. Thus, the focal length f of the device 100 for at least a portion of the visible light emitted by the display screen 104 is not more than, for example, 20 mm (e.g., substantially 12 millimeters or less). A size of the display screen is 30 mm or less. The ERD is at most 14 mm.

Thus, using the lens 108 with relatively high numerical aperture NA, it may be possible to have relatively smaller display size (e.g., 30 mm or less) and relatively small display to lens distance (e.g., 12 mm or less), while meeting a target field of view (FOV) requirement of 80 degrees or higher and an Eye Box requirement of 12 mm or higher.

In some embodiments, the device 100 may result in low cost of production, e.g., due to the reduction of the display size (e.g., display size may be less than 35 mm). In contrast, a conventional device may have a display size or 50 mm or higher. Thus, the device 100 may have reduction in cost of manufacturing (e.g., cost of manufacturing the display screen 104). Such reduction in cost may be even prominent for higher resolution display (e.g., display screen with resolution on 2000 pixels per inch, or higher) manufactured on silicon wafers. In an example, usage of the lens 108 (e.g., a diffractive optical element comprising a plurality of nanostructures or nanoparticles) may allow the benefit of using existing foundry infrastructure of field and stepper equipment, without doing stitching for building large display infrastructure, which may enable faster time to design, test and/or manufacture the device 100. In an example, the device 100 may break a conventional trade-off between display resolution and complexity for a high field of view angle. The display screen to lens distance in the device 100 may be almost half compared to a conventional state of the art device (e.g., the display screen to lens distance in the device 100 may be reduced from 50 mm to about 30 mm or less). Thus, usage of flat lens 108 may result in reduction of the size and/or the price of the device 100, without sacrificing a target field of view (FOV) requirement or an Eye Box requirement.

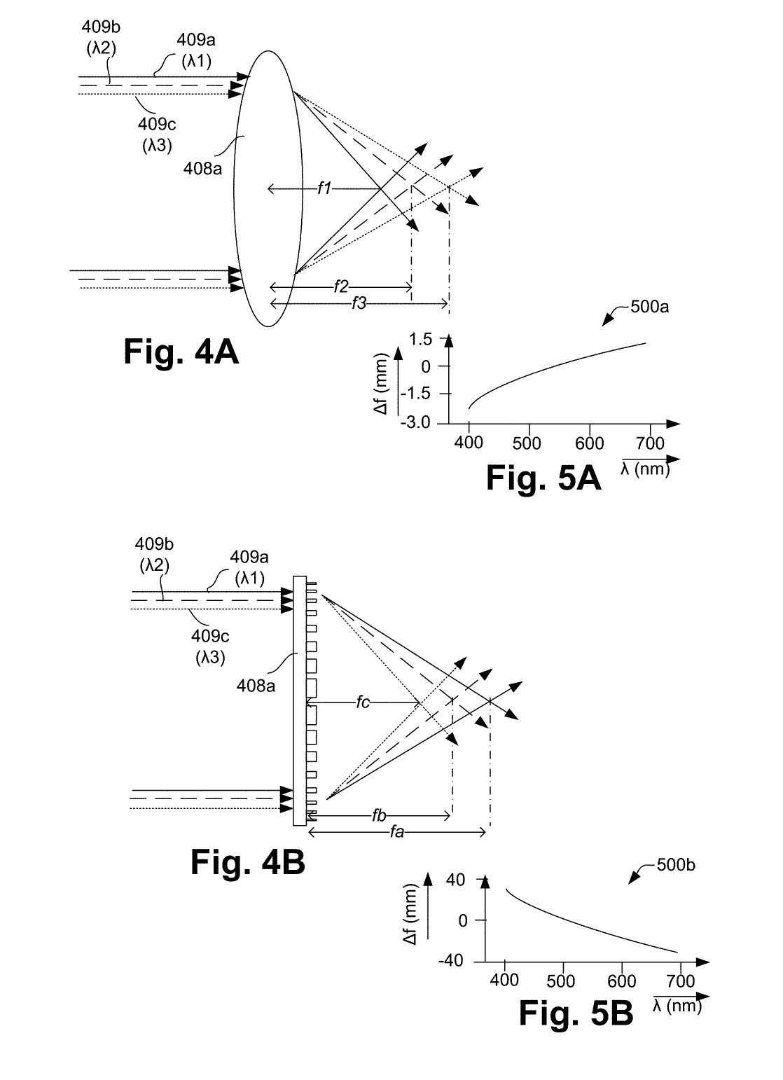

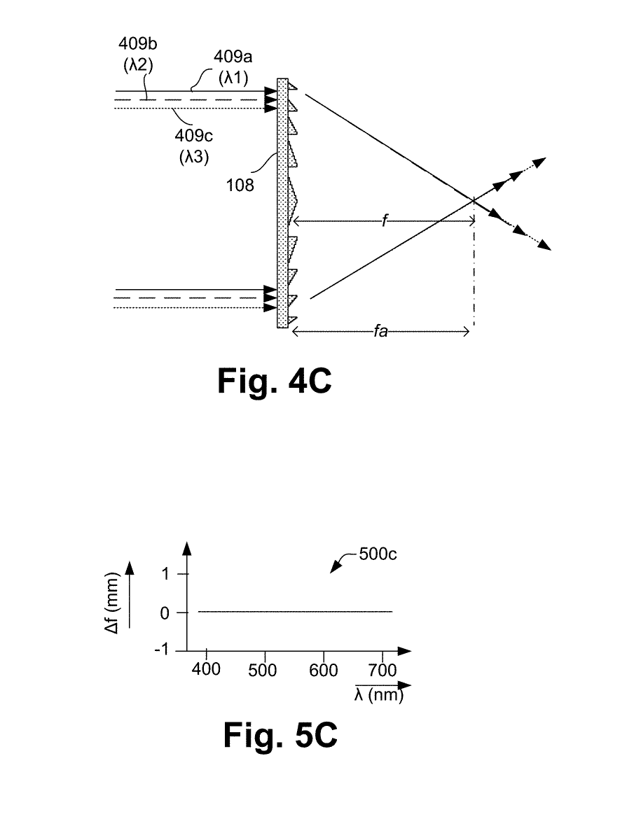

FIGS. 4A-4C illustrate optical response of different types of lenses, according to some embodiments. FIGS. 5A-5C illustrate different graphs 500a, 500b, 500c depicting relationship between wavelength of light and change in focal length for different types of lenses, according to some embodiments.

Referring to FIG. 4A, illustrated is a conventional convex lens 408a receiving light of different wave lengths. For example, light 409a received by the lens 408a has a wavelength of λ1, light 409b received by the lens 408a has a wavelength of λ2, and light 409c received by the lens 408a has a wavelength of λ3. As illustrated, a focal length of the lens 408a for the light 409a of wavelength λ1 is f1, a focal length of the lens 408a for the light 409b of wavelength λ2 is f2, and a focal length of the lens 408a for the light 409c of wavelength λ3 is f3.

The graph 500a of FIG. 5A corresponds to the lens 408a of FIG. 4A. The X axis of the graph 500a represents wavelength A in nm. The Y axis represents a change in focal length (e.g., Δf in mm), as the wavelength A changes. As seen in the graph 500a, for various values of the wavelength A, the focal length is different. Accordingly, the focal length f1, f2, and f3 of the lens 408a, for lights with wavelengths λ1, λ2, and λ3, respectively, are different. Thus, f1, f2, and f3 are different (e.g., f3>f2>f1), and the optical response of the lens 408a is different for lights of different wavelengths.

Referring to FIG. 4B, illustrated is a Fresnel lens 408b receiving light of different wave lengths. For example, light 409a received by the lens 408b has the wavelength of λ1, light 409b received by the lens 408b has the wavelength of λ2, and light 409c received by the lens 408b has the wavelength of λ3. As illustrated, a focal length of the lens 408b for the light 409a of wavelength λ1 is fa, a focal length of the lens 408b for the light 409b of wavelength λ2 is fb, and a focal length of the lens 408b for the light 409c of wavelength λ3 is fc.

The graph 500b of FIG. 5B corresponds to the lens 408b of FIG. 4B. The X and Y axes of the graph 500b are similar to those in FIG. 5A. As seen in the graph 500b, for various values of the wavelength λ, the focal length is different. Accordingly, the focal lengths fa, fb, and fc of the lens 408b, for lights with wavelengths λ1, λ2, and λ3, respectively, are different. Thus, fa, fb, and fc are different (e.g., fa>fb>fc), and the optical response of the lens 408b is different for lights of different wavelengths.

Referring to FIG. 4C, illustrated is an example implementation of the lens 108 of the device 100 receiving light of different wave lengths (e.g., the lens 108 in FIG. 4C is a diffractive optical element comprising a plurality of nanostructures or nanoparticles). Light 409a received by the lens 108 has the wavelength of λ1, light 409b received by the lens 108 has the wavelength of λ2, and light 409c received by the lens 108 has the wavelength of λ3. As illustrated, a focal length of the lens 108 for the light 409a, 409b, and 409c is substantially the same, which is f.

The graph 500c of FIG. 5C corresponds to the lens 108 of FIG. 4C. The X and Y axes of the graph 500c are similar to those in FIG. 5A. As seen in the graph 500c, for various values of the wavelength λ, the focal length is substantially the same. Accordingly, the focal length for lights of various wavelengths are substantially the same. Thus, the lens 108 may have better optical response to light of various wavelengths, e.g., compared to the lenses 408a and 408b of FIGS. 4A-4B.

A Fresnel lens (e.g., the lens 408b of FIG. 4B) may generate an on-axis focus, when illuminated with incident light. That is, the Fresnel lens may not be corrected for most aberrations, e.g., including off-axis, chromatic, spherical, coma, etc. Thus, the field of view and the operating bandwidth of a Fresnel lens may be relatively limited. The Fresnel lens has relatively low focusing efficiency when averaged over the visible spectrum. The lens 108 (e.g., a diffractive optical element comprising the multi-level nanostructures) may not have these limitations. Also, as discussed herein previously, usage of the lens 108 may result in reduction of the size and/or the price of the device 100, without sacrificing a target field of view (FOV) requirement or an Eye Box requirement.

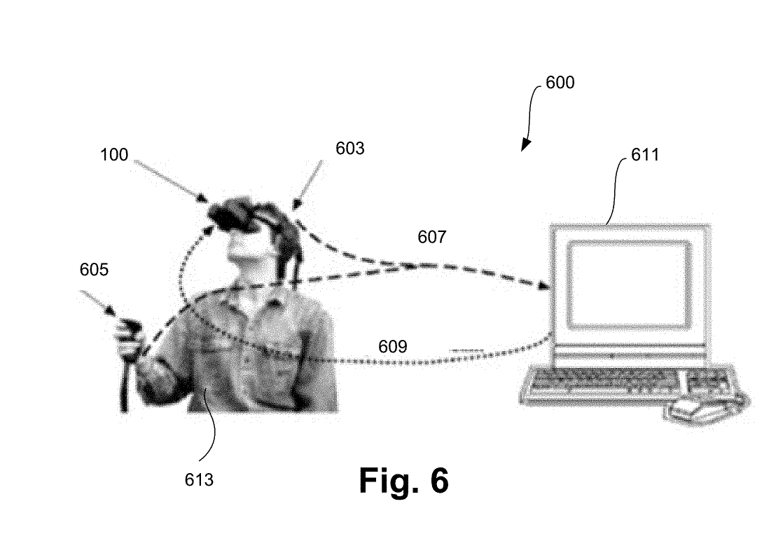

FIG. 6 illustrates an example use case scenario 600 of the device 100 of FIGS. 1A-1B, according to some embodiments. In the scenario 600 of FIG. 6, the device 100 is a head mounted device that is worn by a user 613. The device 100 comprises tracking circuitry 603 that may track a movement of the device 100. For example, when the user 613 moves the head (e.g., which results in corresponding movement in the device 100), such movement may be tracked by the tracking circuitry 603. In some embodiments, the user 613 may also use a handheld input device 605 (e.g., a handheld mouse).

In some embodiments, the scenario 600 may comprise a host 611 (e.g., a computing device) communicating with the device 100. Communication between the host 611 and the device 100 may be via a wireless network, and/or via one or more wired communication links. Communication between the host 611 and the input device 605 may be via a wireless network, and/or via one or more wired communication links.

In some embodiments, the host 611 may receive feedback 607 from the input device 605 and/or the device 100. For example, the feedback 607 from the device 100 may comprise tracking performed by the tracking circuitry 603, current contents displayed by the device 100 on the display screen 104, etc.

In some embodiments, based at least in part on the feedback 607, the host 611 may transmit contents 609 to the device 100. Contents 609 may comprise audio data and/or video data. The device 100 may at least temporarily store the contents 609, and display at least a part of the contents 609 of the display screen 104.

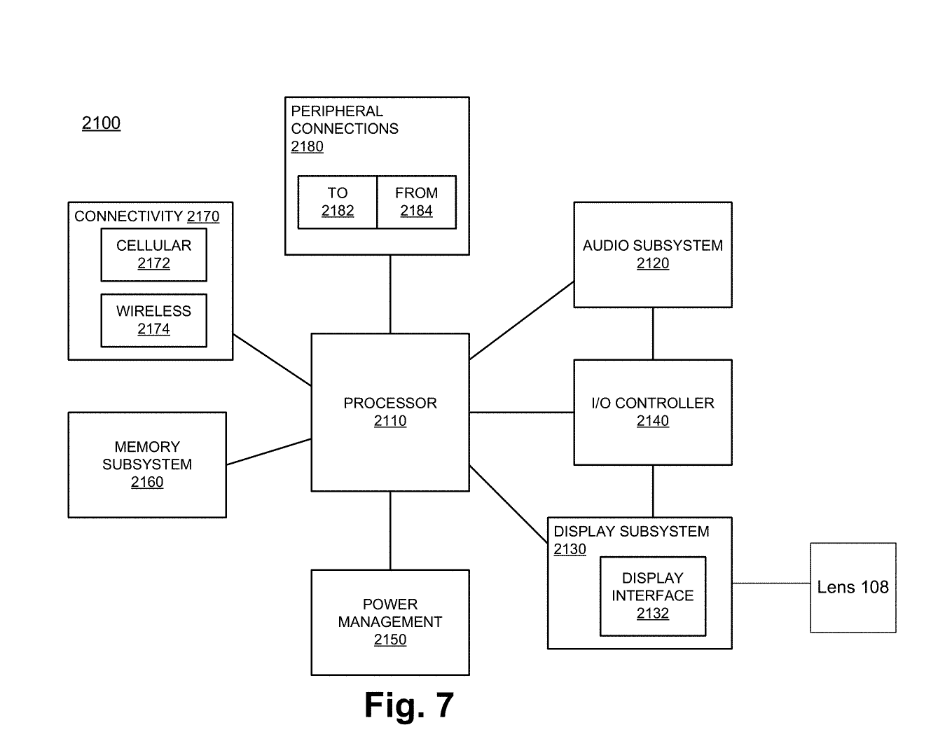

FIG. 7 illustrates a computing device 2100, a smart device, a computing device or a computer system or a SoC (System-on-Chip) 2100, where the computing device 2100 may include an emissive display to emit visible light, and a flat lens optically coupled to the emissive display, according to some embodiments. It is pointed out that those elements of FIG. 7 having the same reference numbers (or names) as the elements of any other figure can operate or function in any manner similar to that described, but are not limited to such.

In some embodiments, computing device 2100 represents an appropriate computing device, such as a computing tablet, a mobile phone or smart-phone, a laptop, a desktop, an IOT device, a server, a set-top box, a wireless-enabled e-reader, or the like. It will be understood that certain components are shown generally, and not all components of such a device are shown in computing device 2100.

In some embodiments, computing device 2100 includes a first processor 2110. The various embodiments of the present disclosure may also comprise a network interface within 2170 such as a wireless interface so that a system embodiment may be incorporated into a wireless device, for example, cell phone or personal digital assistant.

In one embodiment, processor 2110 can include one or more physical devices, such as microprocessors, application processors, microcontrollers, programmable logic devices, or other processing means. The processing operations performed by processor 2110 include the execution of an operating platform or operating system on which applications and/or device functions are executed. The processing operations include operations related to I/O (input/output) with a human user or with other devices, operations related to power management, and/or operations related to connecting the computing device 2100 to another device. The processing operations may also include operations related to audio I/O and/or display I/O.

In one embodiment, computing device 2100 includes audio subsystem 2120, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into computing device 2100, or connected to the computing device 2100. In one embodiment, a user interacts with the computing device 2100 by providing audio commands that are received and processed by processor 2110.

Display subsystem 2130 represents hardware (e.g., display devices) and software (e.g., drivers) components that provide a visual and/or tactile display for a user to interact with the computing device 2100. Display subsystem 2130 includes display interface 2132, which includes the particular screen or hardware device used to provide a display to a user. In one embodiment, display interface 2132 includes logic separate from processor 2110 to perform at least some processing related to the display. In one embodiment, display subsystem 2130 includes a touch screen (or touch pad) device that provides both output and input to a user.

I/O controller 2140 represents hardware devices and software components related to interaction with a user. I/O controller 2140 is operable to manage hardware that is part of audio subsystem 2120 and/or display subsystem 2130. Additionally, I/O controller 2140 illustrates a connection point for additional devices that connect to computing device 2100 through which a user might interact with the system. For example, devices that can be attached to the computing device 2100 might include microphone devices, speaker or stereo systems, video systems or other display devices, keyboard or keypad devices, or other I/O devices for use with specific applications such as card readers or other devices.

As mentioned above, I/O controller 2140 can interact with audio subsystem 2120 and/or display subsystem 2130. For example, input through a microphone or other audio device can provide input or commands for one or more applications or functions of the computing device 2100. Additionally, audio output can be provided instead of, or in addition to display output. In another example, if display subsystem 2130 includes a touch screen, the display device also acts as an input device, which can be at least partially managed by I/O controller 2140. There can also be additional buttons or switches on the computing device 2100 to provide I/O functions managed by I/O controller 2140.

In one embodiment, I/O controller 2140 manages devices such as accelerometers, cameras, light sensors or other environmental sensors, or other hardware that can be included in the computing device 2100. The input can be part of direct user interaction, as well as providing environmental input to the system to influence its operations (such as filtering for noise, adjusting displays for brightness detection, applying a flash for a camera, or other features).

In one embodiment, computing device 2100 includes power management 2150 that manages battery power usage, charging of the battery, and features related to power saving operation. Memory subsystem 2160 includes memory devices for storing information in computing device 2100. Memory can include nonvolatile (state does not change if power to the memory device is interrupted) and/or volatile (state is indeterminate if power to the memory device is interrupted) memory devices. Memory subsystem 2160 can store application data, user data, music, photos, documents, or other data, as well as system data (whether long-term or temporary) related to the execution of the applications and functions of the computing device 2100. In one embodiment, computing device 2100 includes a clock generation subsystem 2152 to generate a clock signal.

Elements of embodiments are also provided as a machine-readable medium (e.g., memory 2160) for storing the computer-executable instructions (e.g., instructions to implement any other processes discussed herein). The machine-readable medium (e.g., memory 2160) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

Connectivity 2170 includes hardware devices (e.g., wireless and/or wired connectors and communication hardware) and software components (e.g., drivers, protocol stacks) to enable the computing device 2100 to communicate with external devices. The computing device 2100 could be separate devices, such as other computing devices, wireless access points or base stations, as well as peripherals such as headsets, printers, or other devices.

Connectivity 2170 can include multiple different types of connectivity. To generalize, the computing device 2100 is illustrated with cellular connectivity 2172 and wireless connectivity 2174. Cellular connectivity 2172 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity (or wireless interface) 2174 refers to wireless connectivity that is not cellular, and can include personal area networks (such as Bluetooth, Near Field, etc.), local area networks (such as Wi-Fi), and/or wide area networks (such as WiMax), or other wireless communication.

Peripheral connections 2180 include hardware interfaces and connectors, as well as software components (e.g., drivers, protocol stacks) to make peripheral connections. It will be understood that the computing device 2100 could both be a peripheral device (“to” 2182) to other computing devices, as well as have peripheral devices (“from” 2184) connected to it. The computing device 2100 commonly has a “docking” connector to connect to other computing devices for purposes such as managing (e.g., downloading and/or uploading, changing, synchronizing) content on computing device 2100. Additionally, a docking connector can allow computing device 2100 to connect to certain peripherals that allow the computing device 2100 to control content output, for example, to audiovisual or other systems.

In addition to a proprietary docking connector or other proprietary connection hardware, the computing device 2100 can make peripheral connections 2180 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, the computing device 2100 may comprise the display screen 104 (e.g., included in the display subsystem 2130), and the lens 108 optically coupled to the display screen 104. As discussed with respect to FIG. 6, the computing device 2100 may receive content from a host, and may temporarily store the content in a memory of the memory subsystem 2160. The processor 2110 (e.g., which may be a graphic processing unit) may cause the contents to be displayed on the display screen 104. The lens 108 may be a flat lens (e.g., a diffractive optical element comprising multiple multi-level nanoparticles, a meta-surface lens comprising one or more meta-materials, etc.), e.g., as discussed in this disclosure.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

We claim:

1. An apparatus comprising:
a display to emit visible light; and
a flat lens optically coupled to the display, wherein a focal length of the flat lens for at least a portion of the visible light is not more than 20 millimeters.

2. The apparatus of claim 1, wherein the flat lens comprises a diffractive optical element.

3. The apparatus of claim 2, wherein the diffractive optical element comprises a plurality of nanostructures, and wherein individual nanostructure has a plurality of levels.

4. The apparatus of claim 3, wherein individual nanostructure has one of 8, 16, or 32 levels.

5. The apparatus of claim 3, wherein:
a first nanostructure comprises: a first plurality of steps on a first side of the first nanostructure, and a second plurality of steps on a second side of the first nanostructure;
a second nanostructure comprises: a third plurality of steps on a first side of the second nanostructure, and a vertical edge on a second side of the second nanostructure; and
a third nanostructure comprises a fourth plurality of steps on a first side of the third nanostructure, and a vertical edge on a second side of the third nanostructure,
wherein the first nanostructure is interposed between the second nanostructure and the third nanostructure.

6. The apparatus of claim 5, wherein:
the first side of the second nanostructure is adjacent to the first side of the first nanostructure; and
the first side of the third nanostructure is adjacent to the second side of the first nanostructure.

7. The apparatus of claim 1, wherein the flat lens is a meta-surface lens comprising one or more meta-materials.

8. The apparatus of claim 1, wherein the focal length of the flat lens is substantially 12 millimeters or less, wherein a size of the display is substantially 30 millimeters or less, and wherein a distance between the flat lens and a point at which an eye of a user is to be placed is at most 14 millimeters.

9. The apparatus of claim 1, wherein a numerical aperture of the flat lens is higher than 0.60.

10. The apparatus of claim 1, wherein the flat lens comprises one or more of: Carbon, Oxygen, Hydrogen, Silicon, or Titanium.

11. The apparatus of claim 1, wherein the flat lens comprises one or more of: Poly(methyl methacrylate) (PMMA), Polyethylene terephthalate (PET), Polystyrene (PS), Polycarbonate (PC), Silicon dioxide, or Titanium dioxide.

12. A system comprising:
a memory to store contents;
a processor to cause the contents to be displayed on a display screen;
the display screen; and
a diffractive optical element between the display screen and a viewing area.

13. The system of claim 12, further comprising:
mounting components to mount the system on a head of a user.

14. The system of claim 12, further comprising:
wireless interface to communicate with another system, and to receive the contents from the another system.

15. The system of claim 14, further comprising:
tracking components to track a movement of the system, and to feedback the tracking of the movement to the another system.

16. The system of claim 12, wherein the diffractive optical element comprises a plurality of multi-level nanostructures.

17. The system of claim 12, wherein the focal length of the diffractive optical element is substantially 12 millimeters or less.

18. A Virtual Reality (VR) display device comprising:
a display screen to display VR scenes; and
a lens optically coupled to the display screen, wherein the lens comprises a plurality of multi-level nanostructures.

19. The VR display device of claim 18, wherein a numerical aperture of the lens is higher than 0.60.

20. The VR display device of claim 18, wherein the lens comprises one or more of: Carbon, Oxygen, Hydrogen, Silicon, or Titanium.
